(19) United States
(12) Patent Application Publication
(10) Pub. No.: US 2002/0026400 A1
(43) Pub. Date: Feb. 28, 2002

(54) System and method to establish trading mechanisms employing auctions and reverse auctions

(75) Inventors: Lalit Narayan, Princeton Junction, NJ (US); Dechu P. Muthana, New York, NY (US)

Correspondence Address: R. Neil Sudol/Henry D. Coleman/William J. Sapone, Coleman Sudol Sapone, P.C., 14th Floor, 708 Third Avenue, New York, NY, 10017, US

(73) Assignee: BondGlobe Inc.

(21) Appl. No.: 09/766,911

(22) Filed: Jan. 22, 2001

Related U.S. Application Data
(60) Provisional application No. 60/227,157, filed on Aug. 22, 2000.

(51) Int. Cl. G06F 17/60

(52) U.S. Cl. 705/37

(57) ABSTRACT

In a method for enabling trading in tradable commodities, an activity rule and a quotation for a reserve price on a tradable commodity are received from a first market participant, the activity rule specifying when receipt of quotes from second market participants for the tradable commodity is to be terminated. After receiving of the quotation and the activity rule from the first market participant, quotes are received from the second market participants regarding the tradable commodity. The receipt of quotes is automatically terminated, pursuant to the activity rule. Subsequently, a best one of the quotes meeting the reserve price is selected, and a trade with the second market participant who placed the best quote is closed, the trade including an effective exchange of the tradable commodity. A plurality of auctions and reverse auctions may be simultaneously monitored, facilitated and executed by a system implementing the method.

### CROSS-REFERENCE TO RELATED APPLICATION

This application relies for priority purposes on U.S. provisional application No. 60/227,157 filed Aug. 22, 2000.

### BACKGROUND OF THE INVENTION

This invention relates to the trading of commodities. More particularly, this invention relates to a method and an associated system providing for the trading of commodities such as financial instruments in an auction or reverse auction format. The method and system of the present invention enable continuous trading between multiple buyers and sellers of standardized tradable products in financial secondary markets.

Tradable commodities include, but are not be limited to, financial instruments such as stocks, bonds, options, futures and annuities, which have a secondary market. The secondary markets for tradable products have typically employed different matching mechanisms including auctions, reverse auctions, double auctions, and continuous double auctions.

An auction is a method of selling an asset to the highest bidder. Auctions are useful in circumstances where the seller is unsure of the price he can get, because the product does not have a fixed and predetermined value. Hence, auctions have been used for unique products that are scarce; they are allocated based on a method of competing bids, which are offered simultaneously, and the best bid is picked.

A reverse auction is a method of bidding the selling price down. A buyer states the specifications of the product he is looking to buy, and the market opens with sellers quoting the price they are willing to fulfill the order with. This method of auction takes the pressure off the buyer, and places it solely on the sellers to meet the order at the best price. Reverse auctions are typically used for products that are price competitive and have a plethora of suppliers who are competing to be chosen by the buyer.

In a double action format, both sellers and buyers submit bids, which are then ranked from the highest to the lowest to generate demand and supply profiles. The market created in this way enables the maximum quantity effective exchanged to be determined. In this format, at any given moment, buyers can make offers and sellers can accept them.

A continuous double auction is a special case of double auction in which many individual transactions are on at any given time, and trading does not conclude as each auction concludes. Currently, marketplaces with multiple buyers and multiple sellers employ a continuous double auction format for enabling continuous trading in financial secondary markets. The continuous double action format is more suited to marketplaces that have multiple buyers and sellers transacting on a tradable product at a given point in time. However, this method does not assure maximum benefit to both parties in illiquid products.

Currently, there is no system available that allows for economically efficient allocation of a tradable product among buyers and sellers in illiquid commodities.

### OBJECTS OF THE INVENTION

An object of the present invention is to provide a method and/or system for facilitating the trading of tradable commodities.

A more particular object of the present invention is to provide a method and/or system providing for the trading of commodities such as financial instruments in an auction or reverse auction format. The method and system of the present invention is thus directed to facilitating or enabling the continuous trading, between multiple buyers and sellers, of standardized tradable products in financial secondary markets.

Another object of the present invention is to provide a method and/or system for matching bid and ask prices to bring about a transaction of maximum benefit for both parties of a transaction.

It is a further object of the present invention to provide a method and/or system that matches orders obviating the afore-stated drawbacks.

It is another object of the present invention to provide an improved method and/or system that matches the best offer among the available quotes to a seller seeking the maximum price, without either party breaking their respective reserve price, within a given time frame.

It is a further object of the invention to provide a system that will enable other similar possibilities enhancing the attractiveness and value of securities traded in auctions.

These and other objects of the present invention will be apparent from the drawings and descriptions herein. It is to be noted that any one embodiment of the present invention may satisfy one or more of the above-described objects, but not necessarily all of the stated objects.

### SUMMARY OF THE INVENTION

Generally, the present invention provides a trading mechanism that employs auctions and reverse auctions to enable continuous trading in the financial secondary market between multiple buyers and multiple sellers, of units of a standardized tradable commodity.

More specifically, a method for enabling trading in tradable commodities comprises, in accordance with the present invention, receiving, from a first market participant, a quotation for a reserve price on a tradable commodity and also receiving, from the first market participant, an activity rule specifying when receipt of quotes from second market participants for the tradable commodity is to be terminated. After receiving of the quotation and the activity rule from the first market participant, quotes are received from the second market participants regarding the tradable commodity. The method further comprises automatically terminating, pursuant to the activity rule, receipt of quotes from the second market participants for the tradable commodity, selecting a best one of the quotes meeting the reserve price, and closing a trade with the second market participant who placed the best quote, the trade including an effective exchange of the tradable commodity.

The activity rule preferably, but not exclusively, specifies a time interval during which quotes are entertained, i.e., received and placed into consideration for closing a trade on the tradable commodity. Where the activity rule includes a time interval, the method of the invention further includes counting out the time interval and terminating receipt of quotes from the second market participants upon lapse of the time interval.

Typically, where the activity rule includes a time interval, the activity rule further specifies an event that commences counting of the time interval. The method then necessarily includes waiting for occurrence of the prescribed event and commencing counting of the time interval upon occurrence of the event.

The interval-triggering event may be the very submission of the reserve price on the tradable commodity. This submission may entail not only a specification of the reserve price but also an identification of the tradable commodity which is the subject of the auction or reverse auction contemplated by the first market participant.

Alternatively, the event triggering the commencement of the counting operation is receipt of a quote meeting the reserve price, that is, a bid which is no less than the reserve price in the case of an auction or an ask which is no greater than the reserve price in the case of a reserve auction. In this case, the auction or reverse auction continues for the predetermined time interval after the receipt of the first quote meeting the reserve price.

It is to be noted that the time interval, as well as the beginning instant thereof, may be preset by a service organization which manages the trading activity. In this case, the mere submission of a reserve price on a tradable commodity signifies acceptance (and therefore submission) of the preset time interval as an activity rule for the particular auction or reverse auction. Alternatively, the time interval and its beginning time may be set by the first market participant at the time the reserve price is submitted. In either case, whether the length of the time interval and its beginning time are set by the management service organization or by the individual participant, the activity rule is considered received by the management service organization from the first market participant for purposes of the present discussion.

Where the activity rule requires termination of quote receipt only upon lapse of a certain time interval after the receipt of a first quote meeting the reserve price, the first market participant is provided with an opportunity to change the reserve price prior to the receipt of a suitable quote, i.e., a quote that is equal to or better than the reserve price. In this case, the method additionally comprises receiving a plurality of quotations from the first market participant prior to receipt of a first one of the quotes. The reserve price which is used in determining trade closure is that quotation from the first market participant which is current upon first receipt of a suitably priced quote from one of the second market participants.

Where the activity rule entails a time interval which does not commence counting immediately upon receipt of the reserve price for an identifiable tradable commodity, the first market participant may also be provided with an opportunity to change the activity rule. For instance, the first market participant might wish to increase or decrease the time interval during which trading quotes are accepted for inclusion in a match search process. Such an option is likely to be exercised when the reserve price is also changed.

The present invention contemplates an automated performance of the various steps. In particular, the receiving of the quotation, the receiving of the activity rule, the receiving of the quotes, the terminating of the receipt of quotes from the second market participants, and the selecting of the best one of the quotes are preferably all performed automatically, in the absence of operator intervention. More particularly, as discussed in detail below, the recognition or interpretation of incoming signals, the monitoring of quote arrival with reference to the preselected activity rule, and the quote selection process are all preferably executed by a properly programmed generic digital computer. In one embodiment of the method, the receiving of the quotation, the receiving of the activity rule, and the receiving of the quotes all entail the reception of signals over a global computer network (the Internet). The methodology employed may include the transmission of information to the first market participant and the second market participant and the reception of choice selections therefrom via World Wide Web pages.

In accordance with another feature of the present invention, the tradable commodity is characterized by multiple identical units having standardized features and comprehensively measurable parameters. More specifically, the tradable commodity is a financial instrument having a secondary market. Even more specifically, the tradable commodity is taken from the group consisting of a stock, a bond, a future, an option, and an annuity.

Where the reserve price is a minimum selling price for the tradable commodity (i.e., an auction quote), the quotes include bids for the tradable commodity and the selecting of the best one of the quotes includes determining whether one of the bids is highest. Where the reserve price is a maximum buying price for the tradable commodity (i.e., a reverse auction quote), the quotes including asks for the tradable commodity and the selecting of the best one of the quotes includes determining whether one of the asks is lowest.

Thus, it is seen that a method (and associated system) in accordance with the present invention, contemplates the monitoring, facilitating, and implementing of simultaneous auctions and reverse auctions. Generally, these auctions and reverse auctions are for different orders. Even if the tradable commodity involved in different auctions and/or reverse auctions has the same unit (e.g., same bond), the other parameters of the order (quantity, etc.) may differ so that the simultaneous auctions and reverse auctions are for different tradable commodities.

Generally, it is contemplated that the trade is closed at a price included in the best quote. However, it is possible to close trades according to a modified rule wherein the price used is that of the next best one of the quotes, provided that the next best quote still meets the reserve price set by the first market participant.

In accordance with one embodiment of the present invention, a system for effectuating commodity trading comprises an electronic or electrical communications link extending to multiple remote users for receiving (a) a quotation for a reserve price on a tradable commodity from a first market participant, (b) an activity rule from the first market participant specifying when receipt of quotes from second market participants for the tradable commodity is to be terminated, and (c) quotes from the second market participants the tradable commodity after receiving of the quotation and the activity rule from the first market participant. The system further comprises a computer operatively connected to the communications link. The computer is programmed to (i) store the quotation, the activity rule and the quotes in a memory or database, (ii) automatically terminate, pursuant to the activity rule, the receipt of quotes from the second market participants for the tradable commodity, (iii) select a best one of the quotes meeting the reserve price, and (iv) close a trade with the one of the second market participants placing the best one of the quotes, the trade including an effective exchange of the tradable commodity.

Where the activity rule specifies a time interval, the computer includes a timer for counting out the time interval. The computer is programmed to terminate receipt of quotes from the second market participants upon lapse of the time interval as indicated by the timer or counter. Where the activity rule further specifies an event the occurrence of which triggers the beginning of the time interval, the computer is further programmed to await occurrence of the event and to commence counting of the time interval upon occurrence of the event.

In accordance with a preferred feature of the present invention, the communications link includes an interface with a global computer network (the Internet). Communication between market participants or traders and the computer may take place through a Web site generated by the computer on the Internet.

A system for effectuating commodity trading comprises, in accordance with another embodiment of the present invention, an electronic or electrical communications link extending to multiple remote users and first signal reception and interpretation or decoding circuitry operatively connected to the communications link for receiving a quotation for a reserve price on a tradable commodity from a first market participant. Second signal reception and interpretation or decoding circuitry is operatively connected to the communications link for receiving an activity rule from the first market participant specifying when receipt of quotes from second market participants for the tradable commodity is to be terminated. Third signal reception and interpretation or decoding circuitry is operatively connected to the communications link for receiving quotes from the second market participants for the tradable commodity after receiving of the quotation and the activity rule from the first market participant. A memory is operatively connected to the first, second, and third signal reception and interpretation or decoding circuitry for storing the quotation, the activity rule and the quotes. A cut-off circuit is operatively linked to the third signal reception and interpretation or decoding circuitry and the memory for automatically terminating, pursuant to the activity rule, the receipt of quotes from the second market participants for the tradable commodity. A selection circuit is operatively tied to the memory and the cut-off circuit for selecting, upon termination of receipt of the quotes, a best one of the quotes meeting the reserve price. A closure implementation circuit is operatively connected to the selection circuit and the memory for closing a trade with the one market participant placing the best quote, where the trade includes an effective exchange of the tradable commodity.

In accordance with a further feature of the present invention, this system further comprising an interface with a global computer network. The first, second, and third signal reception and interpretation or decoding circuitry are operatively connected to the global computer network via the interface.

Where the activity rule specifies a time interval, the cut-off circuit including a timer for counting out the time interval. The cut-off circuit automatically terminates receipt of quotes from the second market participants upon lapse of the time interval.

The selection circuit may include comparison circuitry for determining which of a plurality of bid-type quotes is highest or which of a plurality of ask-type quotes is lowest.

It is to be noted that the present invention provides in part a system and an associated method that match a seller and buyer such that the seller can transact at the best bid/reverse auction quote at any point of time and a buyer can take the best offer/auction quote, accordingly.

### BRIEF DESCRIPTION OF THE DRAWINGS

FIG. 1 is block diagram showing principal components of a system for carrying out the present invention.

FIG. 2 is a flow chart illustrating steps in complying with a customer's request to view available quotes on one or more tradable commodities, in accordance with the present invention.

FIG. 3 is a flow chart illustrating steps in implementing the posting by a potential buyer of a bid quote or a reverse auction quote to buy, or by a potential seller of an offer quote or an auction quote to sell.

FIG. 4 is flow chart of the detailed methodology on how the different types of quotes would be matched by the system of FIG. 1.

FIG. 5 is a block diagram showing selected functional modules of a server computer shown in FIG. 1.

### DEFINITIONS

A “tradable commodity” is used herein to designate an item or product capable of being bought and sold and which has characteristics of existing in multiple units, having comprehensively measurable parameters, having standardized features, and being of non-perishable quality. Comprehensively measurable parameters of an item or product can be accurately measured and specified. The standardization of features means that all units of the item or product are absolutely identical to one another, with no variations between different units for that particular product. A non-perishable product retains its intrinsic value for its term as determined by economic market factors, and does not diminish in such value due to any physical factors such as, wear and tear, for example. Tradable commodities include financial instruments such as stocks, bonds, options, futures and annuities, which have a secondary market. The participants in the secondary market for such a standardized product can place different kinds of quotes such as bid quotes, reverse auction quotes, offer quotes, and auction quotes.

Buyers in a marketplace can place or submit quotes of two types: bid quotes and reverse auction quotes. “Bid quotes” are entered when a buyer wishes to buy a product, states the price he or she is willing to pay for the same and buys it from a seller agreeable to that price. A “reverse auction quote” is a reserve price or maximum price above which the buyer will not pay for a product.

Sellers in a marketplace can also place or submit quotes of two types: offer or ask quotes and auction quotes. An “offer quote” or “ask quote” is entered when a seller makes a quote at which he is willing to sell. When a seller sets the minimum or reserve price less than which he will not sell, it is called an “auction quote.” When a seller quotes the minimum or reserve price for a product, an auction is created.

The term “reserve price” as used herein denotes a lowest price acceptable to a seller of a tradable commodity or a highest price acceptable to a buyer of a tradable commodity. Thus, a reserve price set by a seller is the least amount that the particular seller will accept for sale of a tradable commodity by that seller, while a reserve price set by a buyer is the most that the buyer is willing to pay for a tradable commodity.

The term “quote” as used herein designates an ask quote, an auction quote, a bid quote or a reverse auction quote. A “best quote” is used to mean a quote most desirable to a market participant setting a reserve price. Where the reserve price is set by a seller, a best quote is a bid or reverse auction quote which is highest among a set of bids and/or reverse auction quotes. Conversely, where the reserve price is set by a buyer, a best quote is an ask or auction quote which is lowest among a set of asks and/or auction quotes.

The term “activity rule” is used herein to denote a precept, agenda, algorithm, direction, or instruction which is used to determine how long trading activities, such as the submission of quotes, are allowed to proceed before termination or closure.

Termination of the receipt of quotes occurs when incoming or arriving quotes are no longer accepted for consideration in determining whether there is a match leading to a trade. Thus, market participants or potential market participants might continue to transmit quotes to buy (bids) or quotes to sell (asks) but those transmissions are not entered into the respective list of quotes relevant to a tradable commodity.

A “reserve price” is a price which is least acceptable to the person making a quote. A reserve price specified by a seller is the lowest price for which the seller is willing to sell a tradable commodity. A reserve price specified by a buyer is the most that the buyer is willing to pay for a tradable commodity.

### DESCRIPTION OF THE PREFERRED EMBODIMENTS

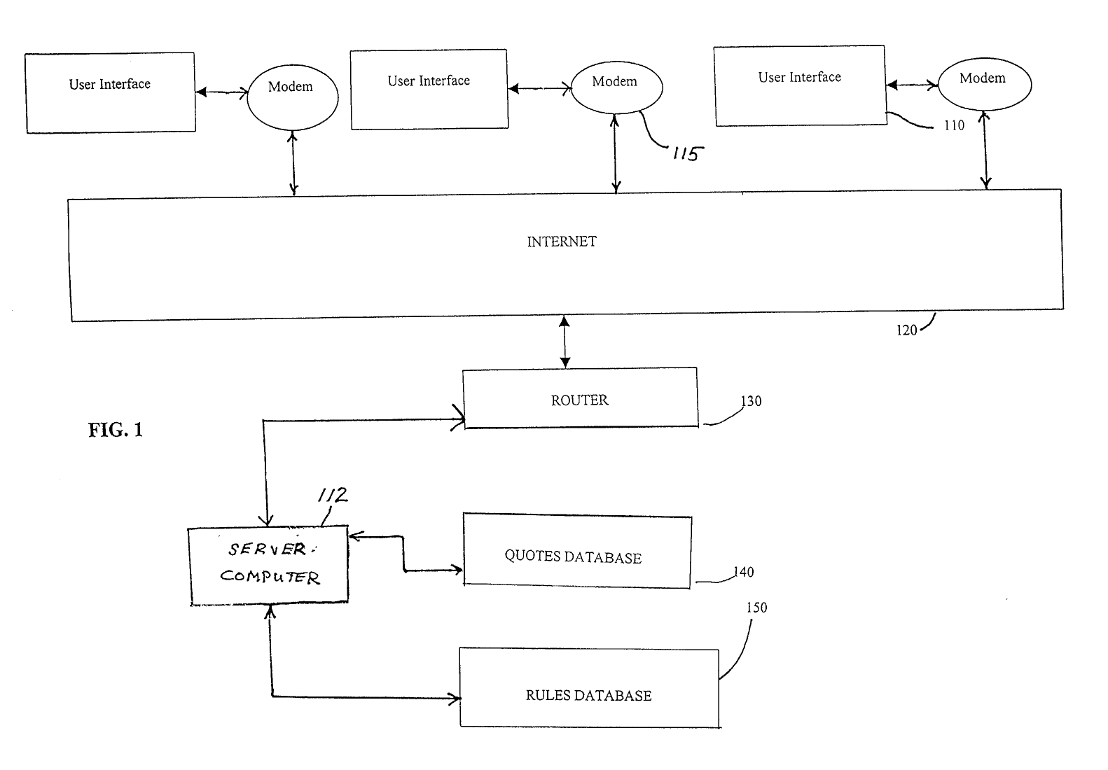

As illustrated in FIG. 1, a system for facilitating and implementing commodity trading comprises a plurality of user interfaces 110 each of which serves as an input and output gateway for communications with a central server 112. User interfaces 110 are connected to a routing module 130 via the global computer network known as the Internet 120, using modems 115 or other connection devices. User interfaces 1 10 generally include personal computers and may more specifically take the form of Internet or Web browsers on those personal computers.

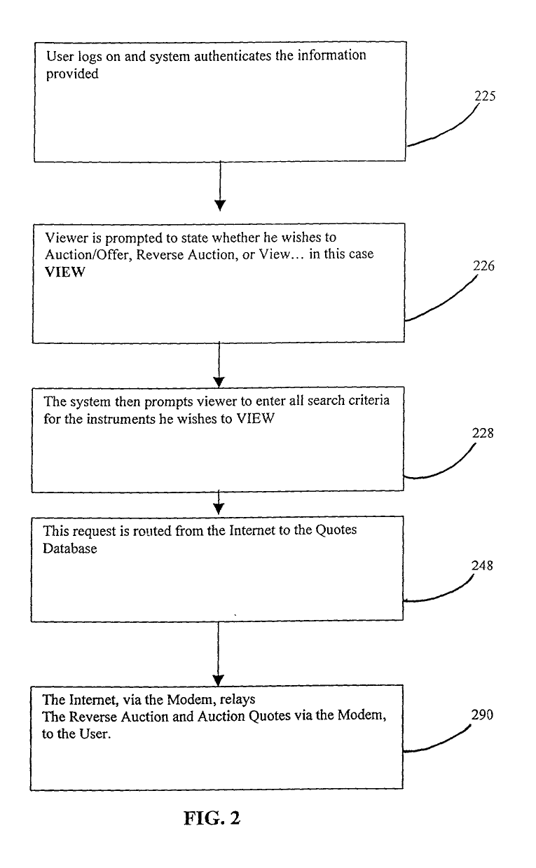

Routing module 130 directs incoming electronic traffic to server computer 112. Server computer 112 in turn is provided with or is connected to a first database 140 for storing quotes arriving from traders via the Internet 120. Server computer 112 is also connected to a second database 150 which stores rules pertaining to trading activities. As shown in FIG. 2, the user logs on and is authenticated in at a step 225. At a step 226, server computer 112 prompts the user to state whether he wishes to buy, sell, or view. Where the user selects the viewing option, server computer 112 prompts the user at a step 228 to enter search criteria for features of the auction he wishes to view, such as the CUSIP of a bond for which the user wishes to view currently pending quotes. If the CUSIP is not available to the user, the user may be prompted to enter more general search criteria such as type of security, maturity, coupon rates, etc.

In response to the user selected search criteria, server computer 112 scans the quotes database 140 in a step 248 for all available quotes for bonds that qualify the particular search criteria. At a subsequent step 290, server computer 112 transmits the quotes back to the respective user interface 110 for display to the user.

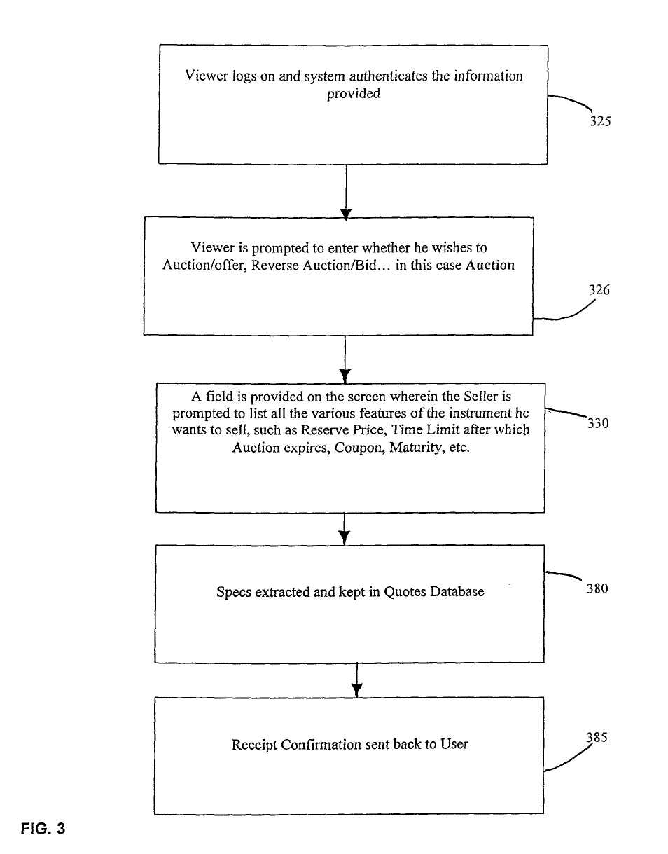

FIG. 3 depicts steps in a process wherein a user logs on to sell a commodity such as a bond in an auction type procedure. The user logs on and is authenticated at a step 325. At a subsequent step 326, the user indicates that he or she wishes to sell, i.e., auction. Where server computer 112 communicates with the user via a Web site, server computer 112 provides a text entry field, with appropriate instructions and prompts, to the user at a step 330. In response, the user enters order specifications such as bid quote, reverse auction quote, offer quote, or auction quote. In the case of a bid or an offer quote, the user specifies the price at which he or she wishes to transact. In the case of an auction quote and a reverse auction quote, he or she specifies a reserve price, i.e., a price level which is least acceptable to the particular user. Besides price, the user may enter other order criteria like quantity, time in force, etc. At a step 380, the specifications are extracted and stored in quotes database 140. At a subsequent step 385, a receipt confirmation is generated by server computer 12 and transmitted to the respective user interface 110 over the Internet 120 for display to the user.

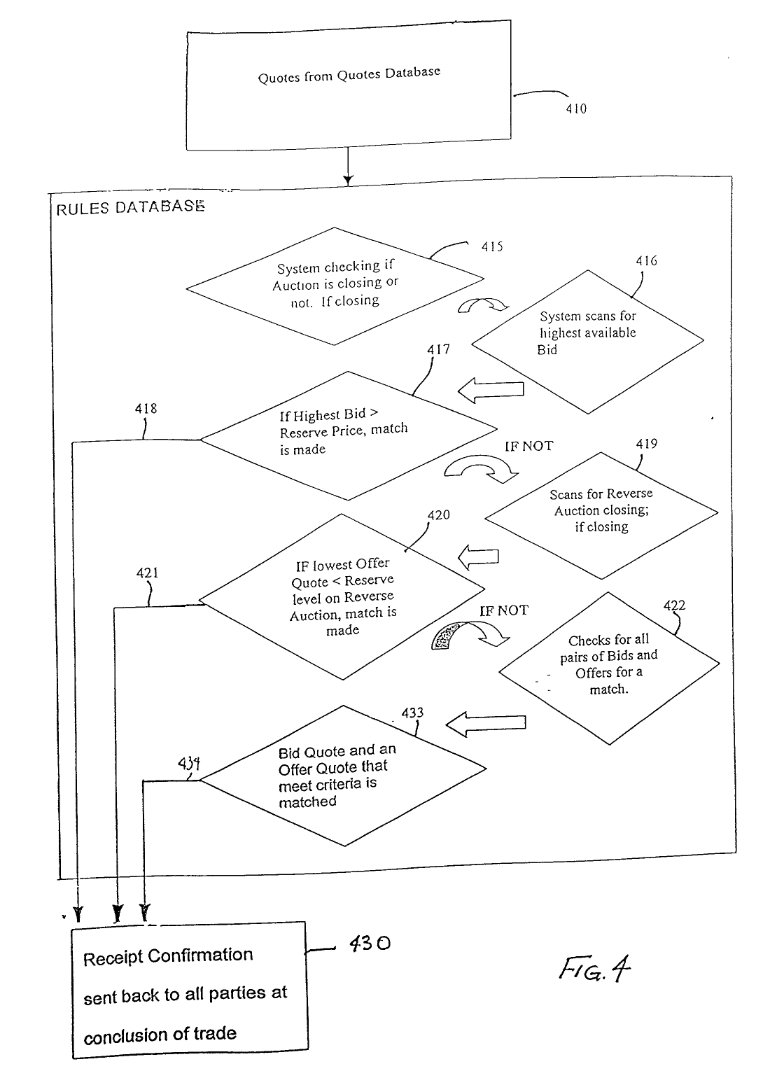

Matching of quotes can happen based on certain activity rules associated with the quotes and stored in database 150 (FIG. 1). The activity rules can be system defined or specified by the user. FIG. 4 relates to one such embodiment. For each bond that is being auctioned, server computer 112 constantly monitors the auction in a step 415 with reference to the applicable activity rule to determine when the auction terminates. At the instant an auction terminates, computer 112 accesses the relevant quote data in database 140 and compares, in a step 417, the highest available bid for the bonds being auctioned with the auction's reserve price. If the reserve price is lower that the value of the highest bid, the transaction is completed, as indicated at 418, and confirmation is sent to all participants in the auction in a step 430. If the reserve price is higher than the value of the highest bid, as determined by computer 112 at step 417, the computer 112 checks at a step 419 there is a reverse auction for the same tradable commodity (e.g., a specified quantity of a specific bond) which is terminating at that instant. If so, server computer 112 compares, in a step 420, the lowest available offer for that quantity of bonds with the reserve price set by the reverse auction. If the lowest available offer is less than the reserve price, then the transaction is completed, as indicated at 421, and confirmation sent to all participants at step 430. If the lowest available offer is higher than the reverse auction's reserve price, computer 1 12 checks all pairs of bids and offers for a match at a step 422. If any of the matches meet the criteria of the auction, as determined at a step 433, the transaction is completed as indicated at 434 and confirmation sent to the participants at step 430.

A particular example using this proposed methodology is discussed below.

In this example, a particular instant, there are four sellers of a particular bond CUSIP 745AQ3RT1 who are ready to sell one unit at prices of 101, 102, 103, and 104. At the same instant, there are four potential buyers of the same bond who are willing to buy one unit at prices of 96, 97, 98, and 99.

In a conventional continuous double auction format, both sellers and buyers submit bids, which are then ranked from the highest to the lowest to generate demand and supply profiles. The buyers and sellers can keep setting new price levels for their bids and offers. This format also allows buyers and sellers to accept each other's quotes at any particular moment. So a seller can transact at the best buy bid, 99, at any point of time. Similarly, a buyer can take the best sell offer, 101. The trade happens at 101 when one of the buyers takes the best sell offer.

In the auction and reverse auction format described above with reference to FIG. 4, the sellers can create an auction and specify the minimum or reserve price that they desire (ask) for the bond. Similarly, the buyers can also create a reverse auction and indicate the maximum or reserve price they are willing to pay (bid) for the bond. In the scenario of this example, the four sellers of a bond would create auctions at reserve quotes of 101, 102, 103, and 104. Similarly, the four potential buyers of the bond would create reverse auctions at reserve bids of 96, 97, 98, and 99. This format also allows buyers and sellers to participate in each other's auctions and reverse auctions at any particular moment. So a seller may enter a valid offer at the reverse auction with the best reserve price of 99 at any point of time. Similarly, a buyer may place a valid bid at the auction with the best reserve price of 101.

According to one type of activity rule storable in database 150 for governing the termination of a quote making process, the auctions and reverse auctions are terminated by server computer 112 at a time that is specified at their creation, i.e., when a market participant submits to server computer 112 a reserve price on a specific tradable commodity such as a specified quantity of a specified bond. Under this activity rule, the buyer and seller participants can keep setting their reserve price levels and closing bell time till the time that an auction/reverse auction receives a valid participation, that is, a quote meeting the set reserve price. The reserve price and bell time are frozen, however, as soon as there is a valid participation.

The closing bell time, i.e., the clock time that the receipt of quotes against a reserve price is terminated, is defined by two parameters, namely, a countable time interval and a commencement time. These activity rule parameters may be selected or defined by server computer 112 or by a market participant setting a reserve price. In the former case, the market participant creating the auction or reserve auction need only specify the reserve price with an indication of the specific tradable commodity (quanitity and unit identification). The transmission of the reserve price over the Internet 120 to server computer 112 automatically entails an acceptance and submission of the predetermined activity rule set by computer 112. In the latter case, the market participant setting the reserve price of an auction or reverse auction selects at least a time interval for the respective activity rule. The commencement time may be defined by server computer 112 or by particular market participant. For example, computer 112 might require that activity rule time intervals commence at the time the reserve price is set or, alternatively, at the time a first quote is received which meets the set reserve price. In another scenario, the market participant creating the auction or reverse auction selects both the time interval and the commencement time of the time interval.

In the present example, if the auction with the most desirable reserve price is scheduled to end in another three minutes and one of the buyers places a valid bid at 101, the other potential buyers can now see that the trade would be executed in three minutes and thus may evaluate if they want to outbid the current bidder. The potential buyer who places the highest bid over 101 (say at 101.2) stays the highest bidder till the auction ends. Now in this case, the transaction is closed at a price of 101.2 as opposed to the continuous double auction format where the trade is closed at 101.

Accordingly, the auction, reverse auction format of FIG. 4 is more economically efficient, as in this example, an auctionable commodity is allocated to the person who valued it most.

It is to be noted that activity rules can vary from auction to auction and from reverse auction to reverse auction. Even where the activity rule is set by host computer 112, the rules can vary across different product categories.

It is to be noted further, that If none of the quotes qualify for a match, server computer 112 may be designed to loop the request, particularly in the case that the computer sets the activity rule to close within a certain time of reserve price receipt. With this procedure, the seller does not have to repeat the process of placing an order to auction.

In the above-discussed trading example, if terminated by server or host computer 112 a specified time interval (e.g., x minutes) after the first valid bid is accepted, is activated or commenced by the submission by one of the buyers of a valid bid at 101. The submission of such a bid signals that the auction will end in the next x minutes. The other potential buyers can evaluate if they want to outbid the current bidder. The one that places the highest bid over 101 (say at 101.2) stays the highest bidder till the auction ends. Now in this case also, the transaction was closed at a price of 101.2 as opposed to earlier, in the continuous double auction format, where the trade was done at 101. Again, this format is also economically efficient, as the bond becomes allocated to the person who valued it most.

Auctions and reverse auctions have been used for products that do not satisfy one or more of the criteria of “Multiple Units”, “Standardized Features”, “Comprehensively Measurable Parameters” and “Non-Perishable Quality”. For example, the products being sold at auctions and reverse auctions are often unique—a second hand machinery, a collector's item, a baseball bat—and do not have multiple units available in the economy that are exactly identical to the unit being auctioned.

There are very few products that satisfy the above criteria—like stocks and bonds. The only format for implementing continuous trading of these products in secondary markets has been the double auction format. This has been the only trading protocol in U.S. financial institutions for over a hundred years.

Implementing a trading mechanism that employs auctions and reverse auctions in conjunction is a novel design application and is fundamentally different from the double auction format for secondary market in standardized products.

The conventional continuous double auction format is most suitable for only liquid markets where there are a lot of buyers and sellers at any given time. Also, that conventional format requires a robust network for implementation, as under this format, buyers and sellers can accept each other's quotes in real time.

In the instant approach, several other unique features of an auction with the potential for several more nuances are made possible. For example, at the instant an auction ends, the match that occurs is such that all outstanding bid and reverse auction quotes become possible matches for an auction quote, and the system will pick the highest quote existing at that point in time. This meets the reserve prices set by both parties, if any, and assures a match wherein the security gets allotted to a bidder who valued it most.

Another variance could be wherein the highest bidder chosen need only pay the next highest price quoted after him. This also assures that the one who valued the security the most got it for an even lesser price than what he was willing to pay, while the seller gets his price within the time stated.

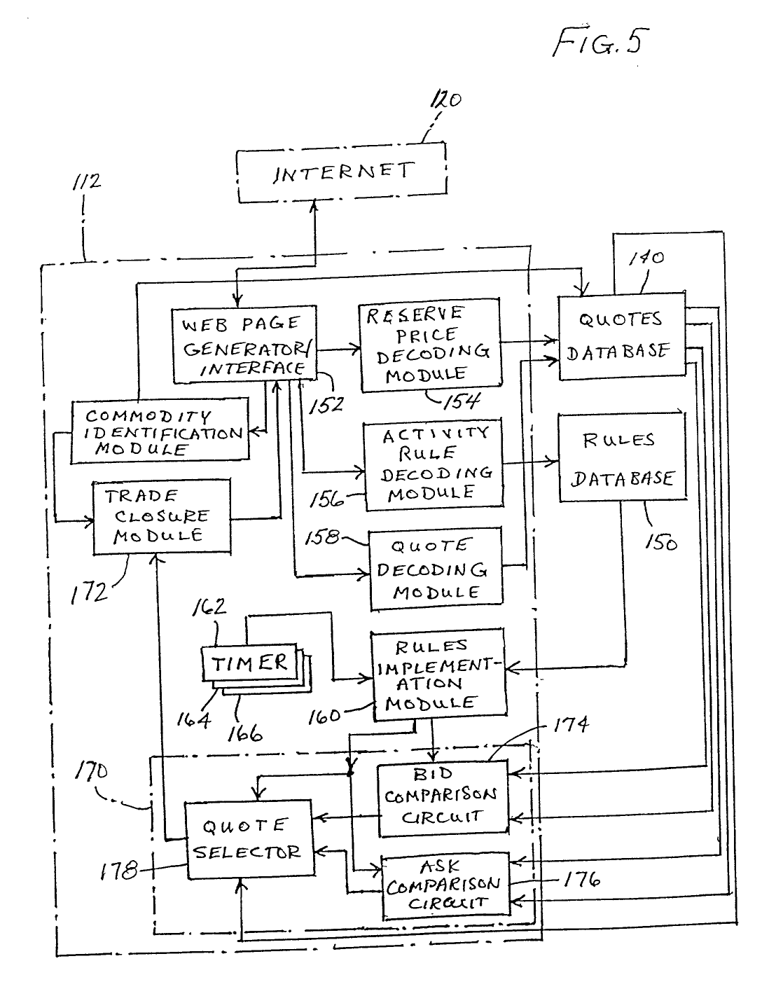

As illustrated in FIG. 5, server computer 112 includes a Web page generator or interface module 152 operatively connected to the Internet 120 for communicating with remote user interfaces or computers 110. A first signal reception and interpretation or decoding module 154 is operatively connected to Web page generator 152 for detecting the reception of a quotation for a reserve price on a tradable commodity from user interface 110 operated by a respective market participant. A second signal reception and interpretation or decoding module 156 is operatively connected to Web page generator 152 for detecting the reception, from the same user interface or computer 110, of an activity rule specifying when receipt of quotes from other market participants for the tradable commodity is to be terminated. A third signal reception and interpretation or decoding module 158 is operatively connected to Web page generator 152 for detecting the receipt of quotes from other market participants for the tradable commodity after receiving of the quotation and the activity rule from the first market participant. Databases or memories 140 and 150 are linked to modules 154, 156, and 158 for storing received quotation, trading quotes, and submitted or accepted activity rules.

Computer 112 further incorporates a cut-off circuit or activity rule implementation module 160 operatively linked to the third signal reception and interpretation or decoding module 158 either directly or via database or memory 150 and to the memory for automatically terminating, pursuant to the activity rule, the receipt of quotes for the tradable commodity. Cut-off circuit or implementation module 160 includes or is connected to a timer 162 which counts out a time interval set by an activity rule. It is to be noted that timer 162 may have multiple incarnations 164, 166, etc., for enabling cutoff circuit or implementation module 160 to track several auctions and reverse auctions simultaneously.

Computer 112 additionally includes a selection circuit 170 operatively tied to database or memory 140 and cut-off circuit or implementation module 160 for selecting, upon termination of receipt of the quotes, a best one of the quotes meeting the reserve price. A trade closure module 172 is operatively connected to selection circuit 170 and memory 140 for closing a trade with the one market participant placing the best quote, where the trade includes taking steps to effect an exchange of the tradable commodity. Trade closure module 172 is connected to a commodity identification module 180 either directly or via database 140 for receiving an identification of the security or other tradable commodity which is the subject of a trade on a quote identified by selection circuit 170 and more particularly quote selector 178. Commodity identification module 180 is connected to Web page generator 152 for detecting and decoding incoming signals pertaining to the identities of commodities.

Selection circuit 170 includes a first comparison circuit 174 for comparing pairs of bid-type quotes to determine which of a plurality of bid-type quotes is highest. Selection circuit 170 includes a second comparison circuit 176 for comparing pairs of ask-type quotes to determine which of a plurality of ask-type quotes is lowest. Selection circuit 170 further includes at least one quote selector 178 operatively connected to comparison circuits 174 and 176 for comparing the highest bid with an auction reserve price or the lowest ask with a reserve auction reserve price. Selection circuit 170 is controlled by rules implementation module 160. Implementation module 160 functions in part as an enabling circuit which triggers the comparison operations of comparison circuits 174, 176 and quote selector 178.

It is to be noted that a trading program implemented pursuant to the above-described system may permit additional trading activities to occur after termination. Thus, where an auction or reverse auction quotation does not result in a trade, the respective market participant may continue with one or more further attempts to close a trade on the same tradable commodity which was the subject of the auction or reverse auction. These continuing attempts to have a trade consummated may be carried out automatically where the market participant submits an indication at the time of creating the auction or reverse auction.

Pursuant to one kind of continuing trading activity, auctions and reverse auctions automatically loop after termination without a match, so that the auction or reverse auction runs automatically for one or more additional cycles. It is possible for the market participant to specify parameters of the continuing trading activities, such as a number of cycles, or total interval, or a final time or date at which termination of the cycling will occur. These parameters are generally specified at the onset of a trading activity, at the time of specification of the auction or reverse quotation.

Pursuant to another kind of continuing trading activity, auction and reverse auction quotations may be automatically converted to a conventional ask or bid quote if no match is found that meets the reserve price. Again, it is preferable for the user to specify this option at the time of creation of the auction or reverse auction as described hereinabove. Under this scenario, a participant or user creates an auction and, if there is no match by termination, has the auction quote automatically transformed to a convention ask so as to become eligible for match in a reverse auction.

Although the invention has been described in terms of particular embodiments and applications, one of ordinary skill in the art, in light of this teaching, can generate additional embodiments and modifications without departing from the spirit of or exceeding the scope of the claimed invention. For example, the activity rule, which determines when incoming trading quotes are turned away, may entail a parameter other than time. One such parameter is the number of quotes received which meet the reserve price. A market participant creating an auction or a reverse auction might define an activity rule according to which the auction or reverse auction terminates upon the receipt of three, four or five quotes meeting the reserve price. Another parameter defining a possible activity rule is the rate at which quotes arrive which meet the reserve price. The creating market participant might specify that if the rate slows to a certain level, then it is time to turn away or ignore further quotes. Of course, it is possible to generate an activity rule which combines more than one parameter.

Accordingly, it is to be understood that the drawings and descriptions herein are proffered by way of example to facilitate comprehension of the invention and should not be construed to limit the scope thereof.

What is claimed is:

1. A method for enabling trading in tradable commodities, comprising:
receiving, from a first market participant, a quotation for a reserve price on a tradable commodity;
also receiving, from said first market participant, an activity rule specifying when receipt of quotes from second market participants for said tradable commodity is to be terminated;
after receiving of said quotation and said activity rule from said first market participant, receiving quotes from said second market participants regarding said tradable commodity;
pursuant to said activity rule, automatically terminating the receipt of quotes from said second market participants for said tradable commodity;
selecting a best one of said quotes meeting said reserve price; and
closing a trade with the one of said second market participants placing said best one of said quotes, said trade including an effective exchange of said tradable commodity.

2. The method set forth in claim I wherein said activity rule specifies a time interval, further comprising counting out said time interval and terminating receipt of quotes from said second market participants upon lapse of said time interval.

3. The method set forth in claim 2 wherein said activity rule further specifies an event that commences counting of said time interval, further comprising waiting for occurrence of said event and commencing counting of said time interval upon occurrence of said event.

4. The method set forth in claim 3 wherein said event is receipt of a quote meeting said reserve price.

5. The method set forth in claim 4 wherein said quotation is an actionable quotation, further comprising receiving a plurality of quotations from said first market participant prior to receipt of a first one of said quotes, said actionable quotation being a last-received one of said plurality of quotations received prior to receipt of said first one of said quotes, whereby said first market participant is able to reset transaction parameters prior to receipt of said first one of said quotes.

6. The method set forth in claim 4 wherein said activity rule is an actionable activity rule, further comprising receiving a plurality of activity rules from said first market participant prior to receipt of a first one of said quotes, said actionable activity rule being a last-received one of said plurality of activity rules received prior to receipt of said first one of said quotes, whereby said first market participant is able to reset transaction parameters prior to receipt of said first one of said quotes.

7. The method set forth in claim 4 wherein said time interval is predetermined, prior to receipt of said quotation, the receiving of said activity rule including an indication of acceptance of said time interval by said first market participant.

8. The method set forth in claim 3 wherein said event is receipt of said quotation and said activity rule.

9. The method set forth in claim I wherein the receiving of said quotation, the receiving of said activity rule, the receiving of said quotes, the terminating of the receipt of quotes from said second market participants, and the selecting of said best one of said quotes are all performed automatically in the absence of operator intervention.

10. The method set forth in claim 9 wherein the receiving of said quotation, the receiving of said activity rule, and the receiving of said quotes all include the receiving of signals over a global computer network.

11. The method set forth in claim 10, further comprising transmitting information to said first market participant and said second market participant via World Wide Web pages.

12. The method set forth in claim 1 wherein said tradable commodity is characterized by multiple identical units having standardized features and comprehensively measurable parameters.

13. The method set forth in claim 12 wherein said tradable commodity is a financial instrument having a secondary market.

14. The method set forth in claim 13 wherein said tradable commodity is taken from the group consisting of a stock, a bond, a future, an option, and an annuity.

15. The method set forth in claim 1 wherein said reserve price is a minimum selling price for said tradable commodity, said quotes including bids for said tradable commodity, the selecting of said best one of said quotes including determining whether one of said bids is highest.

16. The method set forth in claim I wherein said reserve price is a maximum buying price for said tradable commodity, said quotes including asks for said tradable commodity, the selecting of said best one of said quotes including determining whether one of said asks is lowest.

17. The method set forth in claim 1 wherein the closing of said trade includes trading said tradable commodity at a price included in said best one of said quotes.

18. The method set forth in claim 1 wherein the closing of said trade includes trading said tradable commodity at a price included in a next best one of said quotes.

19. The method set forth in claim I wherein the receiving of said activity rule includes:
predetermining said activity rule; and
receiving, from said first market participant, a sign indicating acceptance of the predetermined activity rule.

20. A system for effectuating commodity trading, comprising:
an electronic or electrical communications link extending to multiple remote users for receiving (a) a quotation for a reserve price on a tradable commodity from a first market participant, (b) an activity rule from said first market participant specifying when receipt of quotes from second market participants for said tradable commodity is to be terminated, and (c) quotes from said second market participants said tradable commodity after receiving of said quotation and said activity rule from said first market participant; and
a computer operatively connected to said communications link, said computer being programmed to (i) store said quotation, said activity rule and said quotes in a memory or database, (ii) automatically terminate, pursuant to said activity rule, the receipt of quotes from said second market participants for said tradable commodity, (iii) select a best one of said quotes meeting said reserve price, and (iv) close a trade with the one of said second market participants placing said best one of said quotes, said trade including an effective exchange of said tradable commodity.

21. The system set forth in claim 20 wherein said activity rule specifies a time interval, wherein said computer includes a timer for counting out said time interval, said computer being programmed to terminate receipt of quotes from said second market participants upon lapse of said time interval.

22. The system set forth in claim 21 wherein said activity rule further specifies an event that commences counting of said time interval, wherein said computer is further programmed to await occurrence of said event and to commence counting of said time interval upon occurrence of said event.

23. The system set forth in claim 20 wherein said communications link includes a connection to and interface with a global computer network.

24. The system set forth in claim 20 wherein said reserve price is a minimum selling price for said tradable commodity, said quotes including bids for said tradable commodity, said computer including comparison circuitry for determining which of said bids is highest.

25. The system set forth in claim 20 wherein said reserve price is a maximum buying price for said tradable commodity, said quotes including asks for said tradable commodity, said computer including comparison circuitry for determining which of said asks is lowest.

26. A system for effectuating commodity trading, comprising:
an electronic or electrical communications link extending to multiple remote users;
first signal reception and interpretation means operatively connected to said communications link for receiving a quotation for a reserve price on a tradable commodity from a first market participant;
second signal reception and interpretation means operatively connected to said communications link for receiving an activity rule from said first market participant specifying when receipt of quotes from second market participants for said tradable commodity is to be terminated;
third signal reception and interpretation means operatively connected to said communications link for receiving quotes from said second market participants for said tradable commodity after receiving of said quotation and said activity rule from said first market participant;
memory means operatively connected to said first signal reception and interpretation means, said second signal reception and interpretation means, and said third signal reception and interpretation means for storing said quotation, said activity rule and said quotes;
cut-off means operatively linked to said third signal reception and interpretation means and said memory means for automatically terminating, pursuant to said activity rule, the receipt of quotes from said second market participants for said tradable commodity;
selection means operatively tied to said memory and said cut-off means for selecting, upon termination of receipt of said quotes, a best one of said quotes meeting said reserve price; and
closure means operatively connected to said selection means and said memory means for closing a trade with the one of said second market participants placing said best one of said quotes, where said trade includes an effective exchange of said tradable commodity.

27. The system set forth in claims 26, further comprising an interface with a global computer network, said first signal reception and interpretation means, said second signal reception and interpretation means, and said third signal reception and interpretation means being operatively connected to said global computer network via said interface.

28. The system set forth in claim 27 wherein said interface includes means for generating a site on the World Wide Web to transmit information to said first market participant and said second market participants.

29. The system set forth in claims 26 wherein said activity rule specifies a time interval, said cut-off means including a timer for counting out said time interval, said cutoff means automatically terminating receipt of quotes from said second market participants upon lapse of said time interval.

30. The system set forth in claims 26 wherein said reserve price is a minimum selling price for said tradable commodity, said quotes including bids for said tradable commodity, said selection means including comparison circuitry for determining which of said bids is highest.

31. The system set forth in claims 26 wherein said reserve price is a maximum buying price for said tradable commodity, said quotes including asks for said tradable commodity, said selection means including comparison circuitry for determining which of said asks is lowest.

32. The system set forth in claims 26 wherein said closure means includes means for closing said trade at a price included in said best one of said quotes.
